(19) United States
(12) Patent Application Publication
(10) Pub. No.: US 2016/0132202 A1
(43) Pub. Date: May 12, 2016

(54) COMPUTER-IMPLEMENTED SYSTEM AND METHOD OF ENABLING A USER TO INTERACT WITH AN ELECTRONIC TEST EQUIPMENT USING A MOBILE DEVICE

(71) Applicant: Zurich Instruments Ltd., Zurich (CH)

(72) Inventors: Sadik Hafizovic, Zurich (CH); Flavio Heer, Nurensdorf (CH)

(21) Appl. No.: 14/538,142

(22) Filed: Nov. 11, 2014

(51) Int. Cl. G06F 3/0484; G06F 17/30

(52) U.S. Cl. CPC G06F 3/0484; G06F 17/30879; G06F 17/30887

(57) ABSTRACT

Disclosed is a computer-implemented system and method of enabling a user to interact with an electronic test equipment using a mobile device. The computer-implemented system includes a controller configured to provide a graphical user interface for a computerized device in order to enable a user to interact with an electronic test equipment using the graphical user interface. An optical code generator is configured to generate an optical code identifying a user interface element of the graphical user interface. An optical code presentation arrangement is configured to present an optical representation of the optical code. The mobile device includes an optical reader configured to read the optical representation of the optical code. A user interface element generator is configured to generate on the mobile device the user interface element identified by the optical code read with the mobile device in order to enable a user to interact with the electronic test equipment using the user-interface element.

### BACKGROUND

1. Field of the Invention

This disclosure relates to a computer-implemented system and method of enabling a user to interact with an electronic test equipment using a mobile device. More specifically, the disclosure relates to a computer-implemented system and method of generating a user-interface element on a mobile device in accordance with a graphical user-interface configured to enable the user to interact with an electronic test equipment.

Graphical user interfaces displayed on computerized devices are widely used in the field of electronic testing. A graphical user interface enables a user to interact with an electronic test equipment. Commonly, the graphical user interface is generated either on a screen embedded in the electronic test equipment, on a personal computer (PC) or laptop computer. Instructions to control the electronic test equipment can be entered, for example, by using a keyboard and a mouse connected to the personal computer or laptop computer. Measurement data is presented in the graphical user interface using an electronic display on the electronic test equipment, using the display of the PC or using the display of the laptop computer. Accordingly, a user is enabled to interact with the electronic test equipment by controlling parameters and settings of the electronic test equipment and by observing measurement results of the electronic test equipment.

For some electronic testing arrangements, the test setup may include a large number of test devices, which require a large area such as a large measuring table. In particular, for the testing in interdisciplinary fields, the test setup often includes not only electronic test equipment, but also for example chemical or biological test equipment requiring much space. During use of such a test arrangement, the graphical user interface generated on a computerized device such as a personal computer or laptop computer and the current position of a user performing necessary testing steps at certain test devices may be located far away from each other. Accordingly, it may be difficult for the user to interact with the graphical user interface and to perform required testing steps at the same time. Mobile devices such as mobile phones, tablet computers, etc. may be employed so that the user can have access to the graphical user interface while being at particular locations of the test arrangement. For example, on the mobile device a VNC (Virtual Network Computer) software may be run in order to transfer a copy of the graphical user interface generated on a personal computer or laptop computer to the mobile device. However, it is not convenient and cumbersome for a user to access a graphical user interface designed for a personal computer or laptop computer using a mobile device having a much smaller display than the personal computer or laptop computer.

2. Description of the Related Art

US 2001/0025307 describes a web access mechanism embedded in a device, which comprises a web server and a network interface. The web server generates a device web page which provides a set of user interface functions for the device. The network interface enables access to the device web page by a web browser such that a user of the web browser accesses the user interface function for the device through the device web page.

US 2007/0102633 describes a mass spectrometer that includes an embedded web server. The web server serves one or more web pages to a client computer in data communication with the mass spectrometer via a network. A user may access the web pages via a web browser and read data from the mass spectrometer or control various functions of the spectrometer.

US 2010/0115437 describes an electronic device for collecting and displaying measurement data. The device includes a data interface for obtaining measurement data, a processor and a transport interface. The processor is configured to generate portable graphical user interface information indicating a visual format corresponding to at least one of the measurement data or the electronic device, and to associate the portable graphical user interface information with the measurement data. The transport interface is configured to deliver the measurement data and the associated portable graphical user interface information to a remote display, enabling the remote display to display the measurement data in accordance with the visual format indicated by the portable graphical user interface information.

US 2014/0090001 describes a method and system for implementation of an interactive television application, in particular using quick response code. The interactive television system comprises a communication device, which detects presence of a plurality of quick response codes associated with at least one broadcast content stream, decodes the detected quick response codes to obtain universal resource locators for information content hosted on a server, receives the broadcast content stream and the information content from the server and provides for display the information content along with the broadcast content stream.

### SUMMARY

It is an objective of this invention to provide a method and a system for enabling a user to interact with an electronic test equipment, which overcome at least some of the drawbacks known from the prior art. In particular, it is an objective of this invention to provide a method and a system for enabling a user to interact with an electronic test equipment using a mobile device in a flexible and convenient manner. In particular, it is an objective of this invention to provide a method and a system for enabling a user to interact with an electronic test equipment using a mobile device, which are robust and can be implemented in a simple manner.

According to the present invention, these objectives are achieved through the features of the independent claims. In addition, further advantageous embodiments follow from the dependent claims and the description.

According to the present invention, these objects are achieved through the features of the independent claims. In addition, further advantageous embodiments follow from the dependent claims and the description.

According to the present invention, the above mentioned objectives are particularly achieved in that a computer-implemented system includes a controller configured to provide a graphical user interface for a computerized device in order to enable a user to interact with an electronic test equipment using the graphical user interface, an optical code generator configured to generate an optical code identifying a user-interface element of the graphical user-interface, an optical code presentation arrangement configured to present an optical representation of the optical code, a mobile device including an optical reader configured to read the optical representation of the optical code, and a user-interface element generator configured to generate on the mobile device the user-interface element identified by the optical code read with the mobile device in order to enable a user to interact with the electronic test equipment using the user-interface element. The graphical user interface provided for the computerized device, e.g. a personal computer, allows the user to control the test equipment through, for example, graphical icons and visual indicators of the graphical user interface. The graphical user interface includes a large number of items for interacting with the electronic test equipment such as graphics, tables, diagrams, etc. having different colours, styles of lines, etc. The graphical user interface may be grouped into one or more user interface elements. A user interface element may include text boxes, dialog boxes, display areas, icons, menu bars, tabs, etc. and combinations thereof. An optical code identifying a user interface element is generated by an optical code generator to allow a unique identification of a particular user interface element. Several optical codes may be provided in order to identify several user interface elements. The optical code is presented using an optical code presentation arrangement such as an area of the graphical user interface or a page in a manual of the electronic test equipment. The presented optical code is read quickly and easily using a mobile device including an optical reader. Many mobile devices include an optical reader, for example a camera, and software to read optical codes, because optical code recognition is widely used in a plurality of applications. Therefore, mobile devices usually are enabled to read optical codes without further hardware or software installations. The optical code read by the mobile device is used to request the user interface element generator to generate a user interface element on the mobile device and to enable the user to interact with the electronic test equipment using the user interface element. In a variant, the optical code includes information about how to contact the user interface element generator and how to request the user interface element identified by the optical code. Hence, by simple use of a mobile device, a user interface element of a graphical user interface may be generated on the mobile device in order to interact with the electronic test equipment. Because a graphical user interface element and not a whole graphical user interface are generated on the mobile device, the small screen of the mobile device can be used conveniently and efficiently.

In some embodiments, the controller includes the optical code generator and/or the user-interface element generator. Accordingly, a single controller can provide all necessary functionalities. The system is compact and maintenance of the system is simple. The graphical user interface and the user interface elements may be provided and generated on the basis of different operating systems, such as Windows®, MacOS®, Linux, etc. In a variant, the optical code generator is not included in the controller, but provided, for example, in the form of a stand-alone software application. Access to the stand-alone software application may be restricted to persons having required privileges. Optical codes generated by the stand-alone software application may be stored in tables and transferred to the controller and/or user-interface element generator. In a variant, the user interface element generator is not arranged in the controller, but provided, for example, as a separate server application run on a separated server. The server may include user-interface elements which are specifically designed for mobile devices. The server may be operable to deliver user interface elements in a manner specifically designed for mobile devices.

In some embodiments, the controller includes a web server configured to provide the graphical user interface, to generate the optical code and/or to generate the user interface element. Web servers such as Apache, IIS (Internet Information Services), etc. may be employed. In this way, interaction with the electronic test equipment can be performed using a web browser installed on the mobile device. This allows a user to interact with the test equipment in a convenient and flexible manner, without the need for any special software. Web browsers such as Internet Explorer®, Firefox®, Chrome®, etc. are widely available. This provides the user a wide selection of supported browsers to be used to operate, control or monitor the electronic test equipment. In a variant, the web server is included in the electronic test equipment.

In some embodiments, the controller is configured to provide a graphical user interface which enables a user to interact with an electronic test equipment which includes one or more test instruments. Depending on the type of the test, the complexity of a test set up may vary. Accordingly, the test equipment required for the test set up may include one or more test instruments, for example, an oscilloscope, a spectrum analyzer, a network analyzer, a lock-in amplifier, etc. or any combination thereof.

In some embodiments, the optical code generator is configured to interact with the graphical user interface provided by the controller and generated on the computerized device in order to dynamically generate and present an optical code according to the request of a user. The user interacts with the electronic test equipment using the graphical user interface generated on the computerized device such as a personal computer. During test measurements, the need to have generated a particular graphical user element on a mobile device may arise. One or more graphical user elements of the graphical user interface each include appropriate selectors, such as a right button arranged on the right hand side of a menu bar of the graphical user element, for example, in order to request generation and optical representation of an optical code identifying the respective graphical user element. In one embodiment, the optical code generator generates for each user interface element an associated optical code and stores the generated optical code in a data table. By selection of the right button, the generated optical code is displayed in the graphical user interface along with the user interface element. In another embodiment, by selection of the right button, the optical code generator is requested to generate the respective optical code, which is displayed in the graphical user interface along with the user interface element. The respective optical code has stored necessary data to connect to the user interface element generator in order to request the respective user interface element. Using a mobile device, for example a mobile phone, the optical code is read from the graphical user interface. On the mobile device, data stored in the optical code is extracted and used to connect to the user interface element generator and request generation of the user interface element on the mobile device.

In a preferred embodiment, the optical code generator is configured to generate an optical code which includes a one-dimensional optical bar code or a two-dimensional QR code. The one-dimensional bar code and the two-dimensional QR code are widely used optical machine-readable representation of data. In most mobile devices application required to recognize bar code or QR code are installed. The user may use the mobile device access the optical codes without the need any special software. Any other machine-readable optical code may be employed, such as Code 39, Code 128, Aztec code, Data Matrix, etc.

In some embodiments, the optical code presentation arrangement includes an electronic display device configured to display the optical code and/or a physical object having printed thereon the optical code. In a variant, the optical code may be presented on an electronic display of a computerized device. In a further variant, the optical code may be printed on a physical object, for example on a page in a manual, on a label arranged in the environment of the electronic test equipment, etc.

In some embodiments, the optical code generator is configured to generate an optical code which includes an optical machine-readable representation of a Universal Resource Locator (URL) comprising a unique identifier identifying the user interface element. The URL comprising the unique identifier is stored in the optical code. After the optical code has been read by the mobile device, the data stored in the optical code is extracted. The URL includes the network address of the user interface element generator or the web server which includes the user interface element generator. The unique identifier determines the user interface element which is identified by the optical code. The user interface element generated on the mobile device may be associated with the corresponding element of the user interface generated on the computerized device, such that either one may be used for interaction with the electronic test equipment.

In some embodiments, the optical code generator is configured to generate an optical code which includes an optical machine-readable representation of a Universal Resource Locator (URL) comprising settings defining the user interface element. The URL comprising the settings is stored in the optical code. After the optical code has been read by the mobile device, the data stored in the optical code is extracted. The URL includes the network address of the user interface element generator or the web server which includes the user interface element generator. The settings include, for example, a user interface element type, a scale, a resolution, an aspect ratio, etc. In this way, optical codes do not expire and can be provided in printed form.

Besides a computer-implemented system, the invention concerns a computer-implemented method, including: providing a graphical user-interface for a computerized device in order to enable a user to interact with an electronic test equipment using the graphical user-interface, generating an optical code identifying a user-interface element of the graphical user-interface, presenting an optical representation of the optical code, reading the optical representation of the optical code using a mobile device including an optical reader, and generating on the mobile device the user-interface element identified by the optical code read with the mobile device in order to enable a user to interact with the electronic test equipment using the user-interface element. In a variant, a graphical user interface is provided which enables a user to interact with an electronic test equipment which includes one or more test instruments.

In a variant, providing the graphical user-interface, generating the optical code and/or generating the user-interface element are performed using a controller or a web server.

In another variant, the optical code is generated and presented dynamically according to a request of a user.

In a preferred variant, an optical code is generated which includes a one-dimensional optical bar code or a two-dimensional QR code.

In some embodiments, the optical code is presented using a display device configured to display the optical code and/or using a physical object having printed thereon the optical code.

In a variant, an optical code is generated which includes an optical machine-readable representation of a Universal Resource Locator (URL) and a unique identifier identifying the user-interface element.

In another variant, an optical code is generated which includes an optical machine-readable representation of a Universal Resource Locator (URL) and settings defining the user-interface element.

Beside a computer-implemented system and a computer-implemented method, the inventions concerns a non-transitory computer readable storage medium comprises program instructions to direct a computer-implemented system to perform: providing a graphical user-interface for a computerized device in order to enable a user to interact with an electronic test equipment using the graphical user-interface, generating an optical code identifying a user-interface element of the graphical user-interface, presenting an optical representation of the optical code, reading the optical representation of the optical code using a mobile device including an optical reader.

### BRIEF DESCRIPTION OF THE DRAWINGS

In order to describe the manner in which advantages and features of the disclosure can be obtained, in the following a more particular description of the principles briefly de-scribed above will be rendered by reference to specific embodiments thereof which are illustrated in the appended drawings. These drawings depict only exemplary embodiments of the disclosure and are not therefore to be considered to be limiting of its scope. The principles of the disclosure are described and explained with additional specificity and detail through the use of the accompanying drawings in which:

FIG. 1 illustrates a computer-implemented system including an electronic test equipment, a controller, and a graphical user-interface of a computerized device;

FIG. 2 illustrates presenting in a graphical user-interface of a computerized device a user-interface element along with the optical code identifying the user-interface element;

FIG. 3 illustrates reading with a mobile device an optical code identifying a user-interface element of a graphical user-interface of a computerized device;

FIG. 4 illustrates requesting a user-interface generator to generate a user-interface element identified by the optical code read with the mobile device;

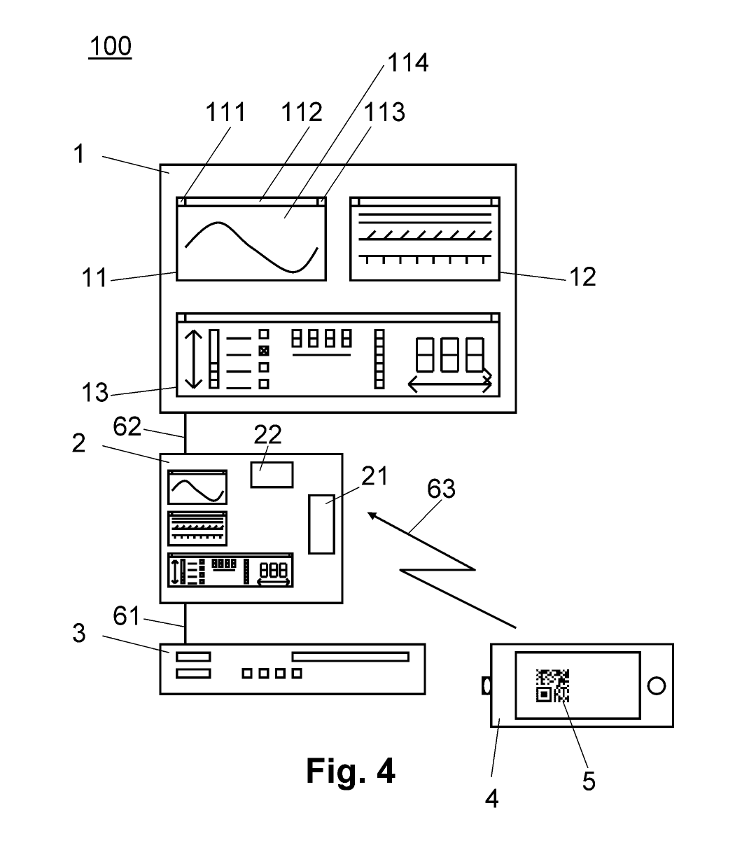

FIG. 5 illustrates generating on a mobile device a user-interface element identified by the optical code read with the mobile device; and

FIG. 6 illustrates steps performed in a method of enabling a user to interact with an electronic test equipment using a mobile device.

### DETAILED DESCRIPTION

The disclosed technology addresses the need to conveniently generate a user-interface element on a mobile device in order to enable a user to interact with an electronic test equipment using the user-interface element. In particular, the disclosed technology addresses the need to identify a user-interface element of a graphical user-interface generated on a computerized device and to conveniently generate the user-interface element on a mobile device in order to enable a user to interact with an electronic test equipment using the user-interface element.

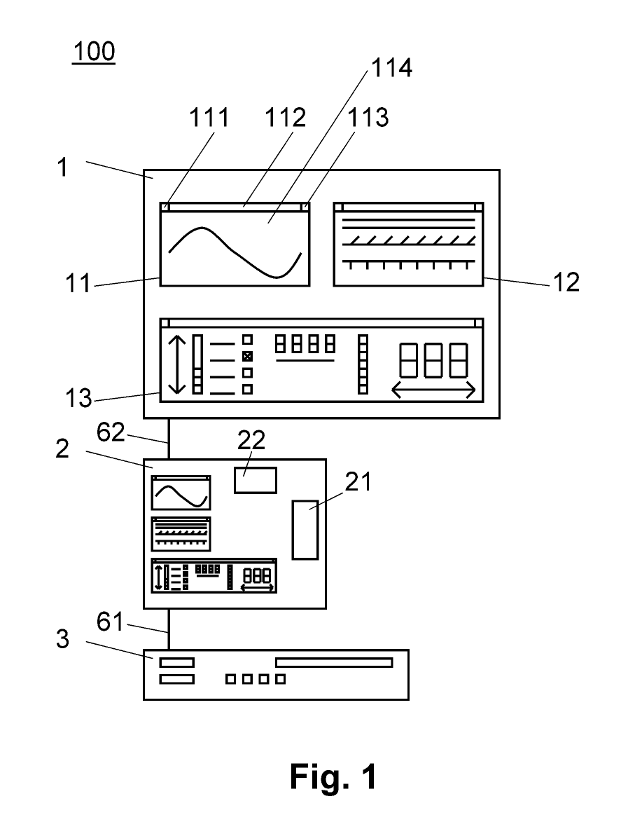

FIG. 1 illustrates a computer-implemented system 100 according to the present invention. The system 100 comprises an electronic test equipment 3, a controller 2 and a computerized device having generated thereon a graphical user interface 1.

The graphical user interface 1 generated on the computerized device includes graphical elements displayed on an electronic display, wherein a user may interact with the graphical user interface 1 using control units such as a keyboard, a mouse, a touch sensitive display, etc.

The electronic test equipment 3 may include any type of test and/or measurement instrument for testing and/or measuring any type of parameters, signals, etc. The electronic test equipment 3 may include an oscilloscope, a spectrum analyzer, a network analyzer, a lock-in amplifier, etc. or any combination thereof.

As illustrated in FIG. 1, the controller 2 is connected to the electronic test equipment 3 through a first line 61. As illustrated in FIG. 1, the controller 2 is connected to the computerized device having generated thereon the graphical user interface 1 through a second line 62. The first line 61 and the second line 62 may include wired and/or wireless communication lines, for example based on directly connecting lines such as USB (Universal serial Bus) cables, based on a LAN (Local Area Network) including Ethernet cables and switches, based on a WLAN (Wireless Local Area Network) including wireless access points, etc.

In a variant, the controller 2 is included in the electronic test equipment 3.

The computerized device having generated thereon the graphical user interface 1 may include a personal computer, a notebook computer, a tablet computer, etc. The graphical user interface 1 may be generated on the basis of an operating system such as Windows®, MacOS®, Linux, etc. In a variant, the graphical user interface 1 may be generated within an application such as a web browser, in particular within Internet Explorer®, Firefox®, Chrome®, etc. The graphical user interface 1 is configured that a user may interact with the electronic test equipment 3 using the graphical user interface 1, for example by pointing to an input field of the graphical user interface 1 using a mouse of the computerized device and by entering a desired value into the input field using a keyboard or a touch screen of the computerized device.

The controller 2 may include a computerized device such as a microcontroller, a personal computer, a server computer, etc. The controller 2 is configured to provide the graphical user interface 1 for the computerized device. The graphical user interface 1 is provided for the computerized device in accordance with the electronic test equipment 3, such that a user is enabled to interact with the electronic test equipment 3, for example by observing measured data and by controlling measurement parameters. In a variant, the controller 2 includes a web server configured to generate the graphical user interface 1 in a web browser running on the computerized device.

Using the graphical user-interface 1, a user may interact with the electronic test equipment 3 in order to perform required measurement steps. The user may set parameters, levels, etc. on the test equipment. The user may start or stop a measurement, display the measurement data, analyze or process the measurement data, etc.

As indicated in FIG. 1, the graphical user interface 1 may include one or more user interface elements 11, 12, 13. FIG. 1 shows an example of the graphical user interface 1 including a first user interface elements 11, a second user interface element 12 and a third user interface element 13. In a variant, the user interface elements 11, 12, 13 are defined by appropriately grouping parts of the graphical user interface 1. Parts of the graphical user interface 1 may include windows, tabs, text boxes, etc.

The first user interface element 11 illustrates an example of a user interface element in the form of a window for displaying measurement data in a display area 114. The first user interface element 11 comprises a left button 111, a title bar 112 and a right button 113. The left button 111 may be configured to minimize, to move, to deactivate, etc. the first user-interface element 11. The title bar 114 may be configured to display information relating to the first user interface element 11, such as the type of the measured data e.g. a description of a particular signal. The right button 113 may be configured to perform additional functions as will be described below. As indicated in FIG. 1, the second user interface element 12 and the third user interface element 13 each include a left button, a title bar, and a right button.

The second user interface element 12 illustrates an example of a user interface element in the form of a window for displaying text lines regarding, for example, measurement data, measurement settings and/or measurement instructions.

The third user interface element 13 illustrates an example of a user interface element in the form of a window for setting various test parameters of the electronic test equipment 3. For example a gauge may be arranged in order to set a level of a parameter, check boxes may be arranged in order to activate or deactivate certain functions such as a signal filter, a digital field for displaying numbers may be arranged for example to display a frequency, a level indicator may be arranged in order for example to display the fill level of a battery, a digital field for displaying numbers may be arranged together with control buttons for example to set the amplitude of a generated signal, etc.

In a variant, a user interface element 11, 12, 13 may consist of a display area for displaying a single numeric value, such as a channel number of a selected channel of the electronic test equipment 3. In another variant, a user interface element 11, 12, 13 may comprise a display area for displaying any information, control element, etc. for performing any required interaction with the electronic test equipment 3.

As illustrated in FIG. 1, the controller 2 includes a user-interface element generator 21 configured to generate a user-interface element on a mobile device 4 upon request. In a variant, the user-interface element generator 21 is included in a web server of the controller 2. In a variant, the user-interface element generator 21 is arranged outside the controller 2, for example in a separate web server.

As illustrated in FIG. 1, the controller 2 includes an optical code generator 22 configured to generate one or more optical codes, each identifying a user interface element 11, 12, 13 of the graphical user interface 1. In some embodiments, the optical code generator 22 is arranged outside the controller 2, for example in the form of a stand-alone software application configured to be run on a computer system. The one or more optical codes generated by the optical code generator 22 include an optical machine-readable representation of data identifying the respective user interface element of the graphical user interface. In an embodiment, an optical code includes a one-dimensional optical bar code. In a preferred embodiment, an optical code includes a two-dimensional optical code such as a QR code (Quick Response code). In some embodiments, an optical code may include an Aztec code, a Data Matrix, a SPARQ code, etc.

The optical code generator 22 is configured to generate optical codes in a static manner and/or in a dynamic manner. In the static manner, the optical code generator 22 generates for each user interface element an associated optical code and stores the generated optical codes in a data table. In the dynamic manner, the optical code generator 22 generates optical codes on request, for example on request of a user interacting with the graphical user interface 1 generated on the computerized device.

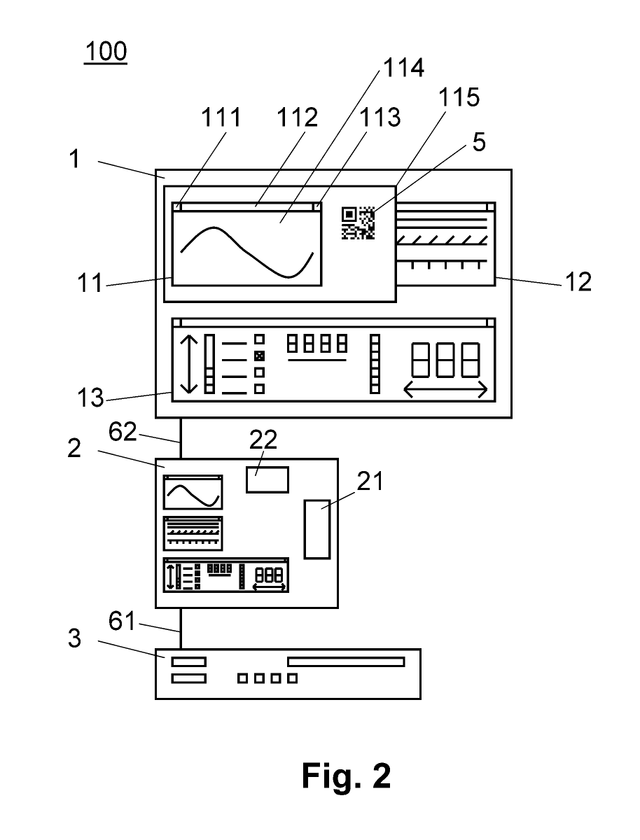

As mentioned above, each user interface element 11, 12, 13 includes a right button which may be configured to modify the user interface element 11, 12, 13 as illustrated in FIG. 2 in connection with the first user interface element 11. When a user selects the right button 113, the first user interface element 11 is modified in such a manner that an optical code is presented together with the first user interface element 11. Selection of the right button 113 may include pointing and clicking the right button 113 using a mouse. As illustrated in FIG. 2, the first user interface element 11 may be presented in a temporary window 115 which includes the first user interface element 11 and an optical code 5 identifying the first user interface element. In case optical codes are generated in a static manner, the optical code 5 is retrieved from the respective data table before being presented. In case optical codes are generated in dynamic manner, the optical code generated 22 is requested to generate the optical code 5, which is presented thereafter. Each of the user interface elements 11, 12, 13 of the graphical user-interface 1 may include a right button in order to present the user interface element 11, 12, 13 together with an optical code identifying the user interface element 11, 12, 13.

In a variant, each user interface element 11, 12, 13 is presented at all times together with the optical code identifying the user interface element 11, 12, 13. No further actions, such as pointing and clicking with a mouse, are required in order to present the optical code identifying the respective user interface element 11, 12, 13.

In a variant, optical codes identifying user interface elements 11, 12, 13 are presented in printed form, such as in a booklet, a manual, a label, etc. The booklet, manual, label, etc. may be arranged in the environment of the electronic test equipment, being easily accessible by a user working with the electronic test equipment. In a variant, optical codes are printed on the electronic test equipment. In a variant, optical codes are printed on labels arranged along a measuring table.

Accordingly, an optical code presentation arrangement, which is configured to present an optical representation of the generated optical codes, is implemented using either the graphical user interface 1 of a computerized device or using a physical object having printed thereon the optical code.

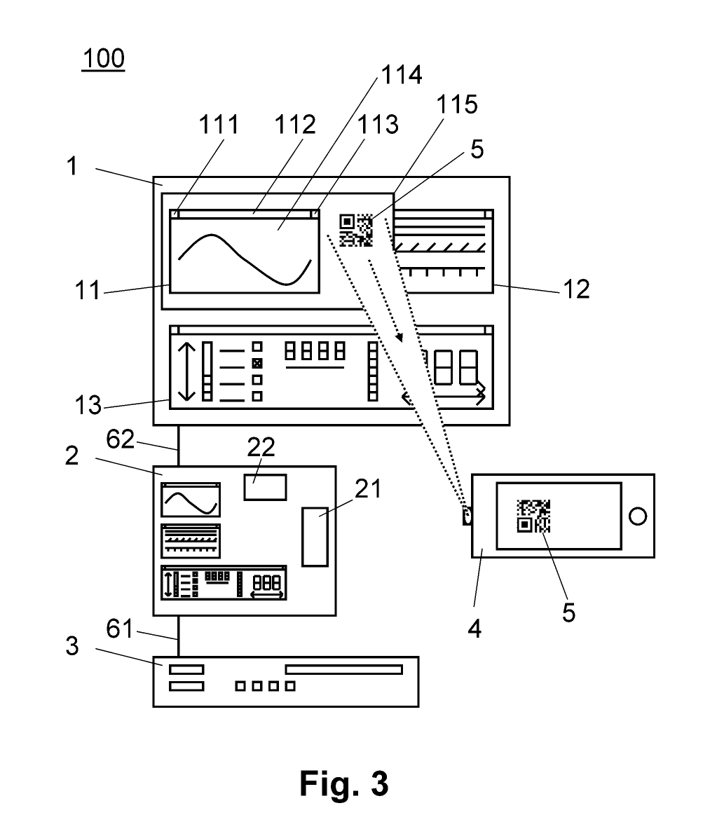

As illustrated in FIG. 3, a mobile device 4 is provided, such as a smartphone, a mobile phone, a handheld device, a tablet, etc. The mobile device 4 includes an optical code reader configured to read the representation of the optical code 5 identifying a respective user interface element 11, 12, 13. For example, the mobile device 4 includes a camera for capturing the optical code 5.

As described above, upon request, the user interface element generator 21 is configured to generate the user interface element 11, 12, 13 on the mobile device 4, in accordance to the optical code 5 which was read by the mobile device 4. In a variant, the user interface generator 21 is included in a web server of the controller 2. The mobile device 4 is configured to communicate with the web server through a communication channel 63, for example on the basis of a WLAN. In a variant, the mobile device 4 requests the user interface element 11, 12, 13 by sending a HTTP (Hyper Text Transfer Protocol) request to the web server including the user interface element generator 21. The mobile device 4 is configured to use the optical code 5 to send an appropriate request. In a variant, the mobile device 4 is configured to extract from the optical code 5 an identification number identifying the user-interface element 11, 12, 13. In a variant, the mobile device is configured to extract from the optical code 5 an URL (Unified Resource Locator) identifying the web server and the user-interface element 11, 12, 13. In a variant, the mobile device is configured to extract from the optical code parameters and settings defining the user-interface element 11, 12, 13. In a variant, the mobile device has stored the address of the web server and the request to the web server is sent using this address together with an identification number extracted from the optical code 5, wherein the extracted identification number identifies the user interface element 11, 12, 13. Accordingly, the user interface generator 21 is enabled to generate the appropriate user-interface element 11, 12, 13 on the mobile device 4. In a variant, the mobile device 4 is configured to extract an URL from the optical code 5. The web server is accessed using the extracted URL, wherein the URL identifies the user interface element 11, 12, 13 which shall be generated on the mobile device 4. In a variant, requesting the user-interface element 11, 12, 13 is based on parameters and settings extracted from the optical code 5. Such parameters and settings may include, for example, a user interface element type, a scale, an aspect ratio etc.

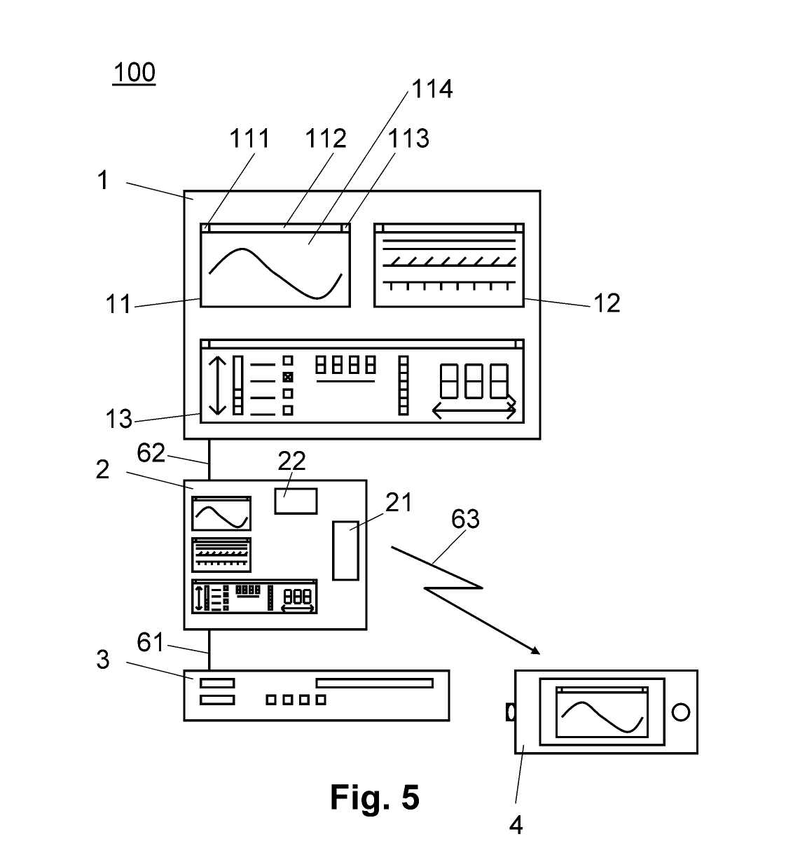

As illustrated in the FIG. 5, the user interface element 11 is generated on the mobile device 4, so that the user can interact with the electronic test equipment 3 using the user interface element 11. Interaction is performed using the communication channel 63 between the controller 2 and the mobile device 4. In a variant, interaction is performed using a communication channel between the electronic test equipment 3 and the mobile device 4.

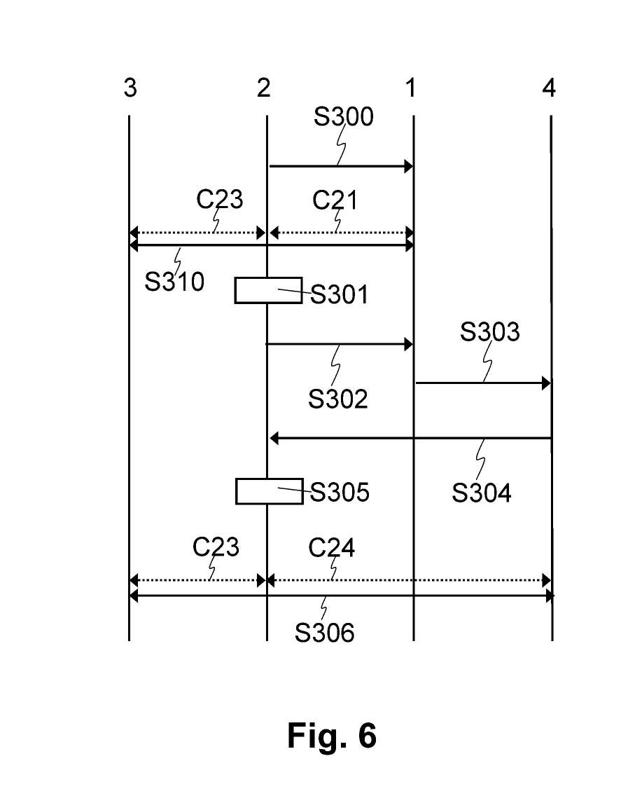

FIG. 6 illustrates a computer-implemented method according to the present invention. In step S300, a controller 2 provides a graphical user interface 1 on a computerized device in order to enable a user to interact with an electronic test equipment. The step of providing the graphical user interface 1 may or may not include the step of generating the graphical user interface on the computerized device. In step 310, the user interacts with the electronic test equipment using the graphical user interface 1 provided by the controller 2. As illustrated in FIG. 6, this interaction is established through the controller 2, since the controller 2 communicates on the one side with the graphical user interface 1 through the communication C21 and on the other side with the electronic test equipment 3 through the communication C23. In step S301, a code generator 22 generates an optical code identifying a user-interface element 11, 12, 13 of the graphical user interface 1. In step S302, the generated optical code 5 is presented on an optical code representation arrangement, for example on an electronic display device or a physical object having printed thereon the optical code. In step S303, a mobile device 4 including an optical reader reads the optical code 5 presented by the optical code representation arrangement. In step S304, the mobile device 4 extracts data from the optical code 5 and sends a request to a user interface element generator 21. In step S305, the user interface element generator 21 generates the user interface element 11 identified by the optical code 5 on the mobile device 4 in order to enable a user to interact with the electronic test equipment 3. In step S306, the user interacts with the electronic test equipment 3 using the user interface element 11 generated on the mobile device 4. The respective interaction is established through the controller 2, since the controller 2 communicates on the one side with the graphical user interface element generated on the mobile device 4 through the communication C24 and on the other side with the electronic test equipment 3 through the communication C23.

In some embodiments, the present disclosure includes individual functional blocks comprising devices, device components, steps or routines embodied in software, hardware, or combinations of software and hardware.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Systems and/or methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing systems and/or methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in the present disclosure.

It should be emphasized that the above-described embodiments of the present disclosure are merely possible examples of the present disclosure set forth for a clear understanding of the principles of the disclosure. Many variations and modifications may be made to the above-described embodiments without departing substantially from the spirit and principles of the disclosure. The modifications and variations are intended to be included herein within the scope of this disclosure and protected by the claims.

### LIST OF REFERENCES

1 graphical user-interface
11 user-interface element, first user-interface element
12 second user-interface element
13 third user-interface element
111 left button
112 title bar
113 right button
114 display area
115 temporary window
2 controller
21 user-interface element generator
22 optical code generator
3 electronic test equipment
4 mobile device
5 optical code
61 first line
62 second line
63 communication channel

What is claimed is:

1. A computer-implemented system, including:
a controller configured to provide a graphical user interface for a computerized device in order to enable a user to interact with an electronic test equipment using the graphical user interface;
an optical code generator configured to generate an optical code identifying a user interface element of the graphical user interface;
an optical code presentation arrangement configured to present an optical representation of the optical code;
a mobile device including an optical reader configured to read the optical representation of the optical code;
a user interface element generator configured to generate on the mobile device the user interface element identified by the optical code read with the mobile device in order to enable a user to interact with the electronic test equipment using the user-interface element.

2. The computer-implemented system of claim 1, wherein the controller includes the optical code generator and/or the user interface element generator.

3. The computer-implemented system of claim 1, wherein the controller includes a web server configured to provide the graphical user interface, to generate the optical code and/or to generate the user interface element.

4. The computer-implemented system of claim 1, wherein the controller is configured to provide a graphical user interface which enables a user to interact with an electronic test equipment which includes one or more test instruments.

5. The system of claim 1, wherein the optical code generator is configured to interact with the graphical user interface provided by the controller and generated on the computerized device in order to dynamically generate and present an optical code according to a request of a user.

6. The system of claim 1, wherein the optical code generator is configured to generate an optical code which includes a one-dimensional optical bar code or a two-dimensional QR code.

7. The system of claim 1, wherein the optical code presentation arrangement includes an electronic display device configured to display the optical code and/or a physical object having printed thereon the optical code.

8. The system of claim 1, wherein the optical code generator is configured to generate an optical code which includes an optical machine-readable representation of a Universal Resource Locator (URL) comprising a unique identifier identifying the user interface element.

9. The system of claim 1, wherein the optical code generator is configured to generate an optical code which includes an optical machine-readable representation of a Universal Resource Locator (URL) comprising settings defining the user interface element.

10. A computer-implemented method, including:
providing a graphical user interface for a computerized device in order to enable a user to interact with an electronic test equipment using the graphical user interface;
generating an optical code identifying a user interface element of the graphical user interface;
presenting an optical representation of the optical code;
reading the optical representation of the optical code using a mobile device including an optical reader;
generating on the mobile device the user-interface element identified by the optical code read with the mobile device in order to enable a user to interact with the electronic test equipment using the user interface element.

11. The computer-implemented method of claim 10, wherein a graphical user interface is provided which enables a user to interact with an electronic test equipment which includes one or more test instruments.

12. The computer-implemented method of claim 10, wherein providing the graphical user interface, generating the optical code and/or generating the user interface element is performed using a controller or a web server.

13. The computer-implemented method of claim 10, wherein the optical code is generated and presented dynamically according to a request of a user.

14. The computer-implemented method of claim 10, wherein an optical code is generated which includes a one-dimensional optical bar code or a two-dimensional QR code.

15. The computer-implemented method of claim 10, wherein the optical code is presented using an electronic display device configured to display the optical code and/or using a physical object having printed thereon the optical code.

16. The computer-implemented method of claim 10, wherein an optical code is generated which includes an optical machine-readable representation of a Universal Resource Locator (URL) comprising a unique identifier identifying the user-interface element.

17. The computer-implemented method of claim 10, wherein an optical code is generated which includes an optical machine-readable representation of a Universal Resource Locator (URL) comprising settings defining the user interface element.

18. A non-transitory computer readable storage medium, comprising program instructions to direct a computer-implemented system to perform:
providing a graphical user interface for a computerized device in order to enable a user to interact with an electronic test equipment using the graphical user interface;
generating an optical code identifying a user interface element of the graphical user interface;
presenting an optical representation of the optical code;
reading the optical representation of the optical code using a mobile device including an optical reader;
generating on the mobile device the user interface element identified by the optical code read with the mobile device in order to enable a user to interact with the electronic test equipment using the user interface element.
